(19) United States
(12) Patent Application Publication
(10) Pub. No.: US 2021/0358340 A1
(43) Pub. Date: Nov. 18, 2021

(54) Sports Themed Furniture Assembly

(71) Applicant: Freddie Mathis, Memphis, TN (US)

(72) Inventor: Freddie Mathis, Memphis, TN (US)

(21) Appl. No.: 15/930,495

(22) Filed: May 13, 2020

(51) Int. Cl. G09F 7/16; A47C 19/02; A47B 13/00; A47B 67/00; A47B 88/944

(52) U.S. Cl. CPC G09F 7/16; A47C 19/022; A47B 88/944; A47B 67/005; A47B 13/003

(57) ABSTRACT

A sports themed furniture assembly for a bedroom includes an article of furniture, which in turn comprises a plurality of elements. The elements of the plurality of elements are interconnected. At least one of the elements comprises a sport module, which depicts at least one of a team name, a team logo, a team name initial, a sport name, a sporting league name, a sporting league acronym, and a piece of equipment that is utilized in a sport. The article of furniture is one of a plurality of articles of furniture that can at least partially furnish a sports themed room.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to furniture assemblies and more particularly pertains to a new furniture assembly for a bedroom.

### (2) Description of Related Art Including Information Disclosed Under 37 CFR 1.97 and 1.98

The prior art relates to furniture assemblies. Prior art furniture assemblies may comprise an article of furniture having a logo attached thereto and an article of furniture having a portion thereof shaped as a piece of sporting equipment.

### BRIEF SUMMARY OF THE INVENTION

An embodiment of the disclosure meets the needs presented above by generally comprising an article of furniture, which in turn comprises a plurality of elements. The elements of the plurality of elements are interconnected. At least one of the elements comprises a sport module, which is configured for depicting at least one of a team name, a team logo, a team name initial, a sport name, a sporting league name, a sporting league acronym, and a piece of equipment that is utilized in a sport. The article of furniture is one of a plurality of articles of furniture. The plurality of articles of furniture is configured to at least partially furnish a sports themed room.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a sports themed furniture assembly according to an embodiment of the disclosure.

FIG. 2 is an isometric perspective view of an embodiment of the disclosure.

FIG. 3 is a detail view of an embodiment of the disclosure.

FIG. 4 is a front view of an embodiment of the disclosure.

FIG. 5 is a front view of an embodiment of the disclosure.

FIG. 6 is a front view of an embodiment of the disclosure.

FIG. 7 is a front view of an embodiment of the disclosure.

### DETAILED DESCRIPTION OF THE INVENTION

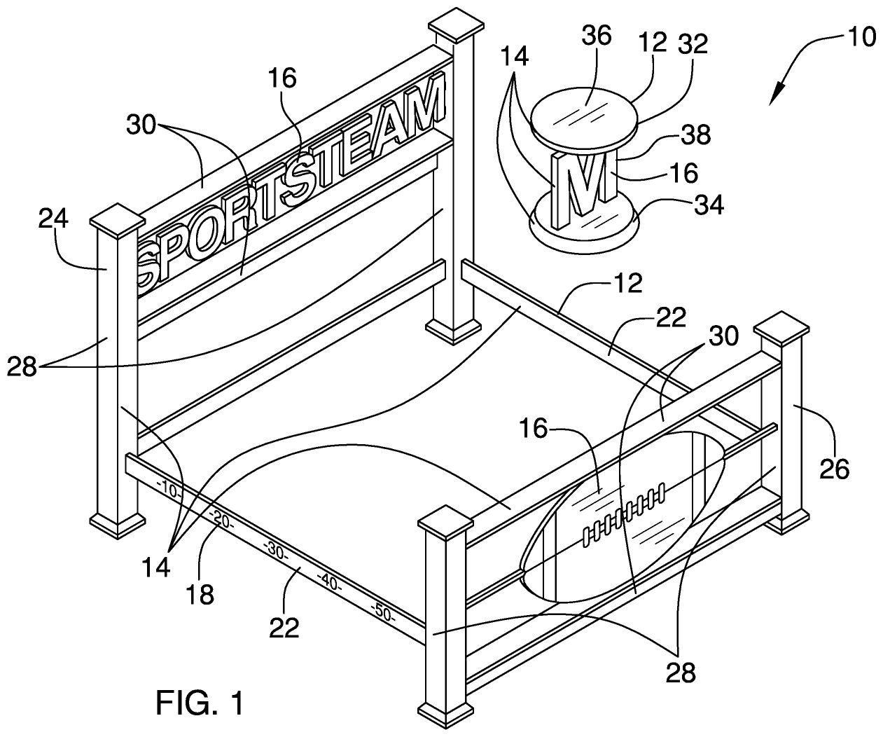

With reference now to the drawings, and in particular to FIGS. 1 through 7 thereof, a new furniture assembly embodying the principles and concepts of an embodiment of the disclosure and generally designated by the reference numeral 10 will be described.

As best illustrated in FIGS. 1 through 7, the sports themed furniture assembly 10 generally comprises an article of furniture 12, which in turn comprises a plurality of elements 14. The elements 14 of the plurality of elements 14 are interconnected. At least one of the elements 14 comprises a sport module 16, which is configured for depicting at least one of a team name, a team logo, a team name initial, a sport name, a sporting league name, a sporting league acronym, and a piece of equipment that is utilized in a sport.

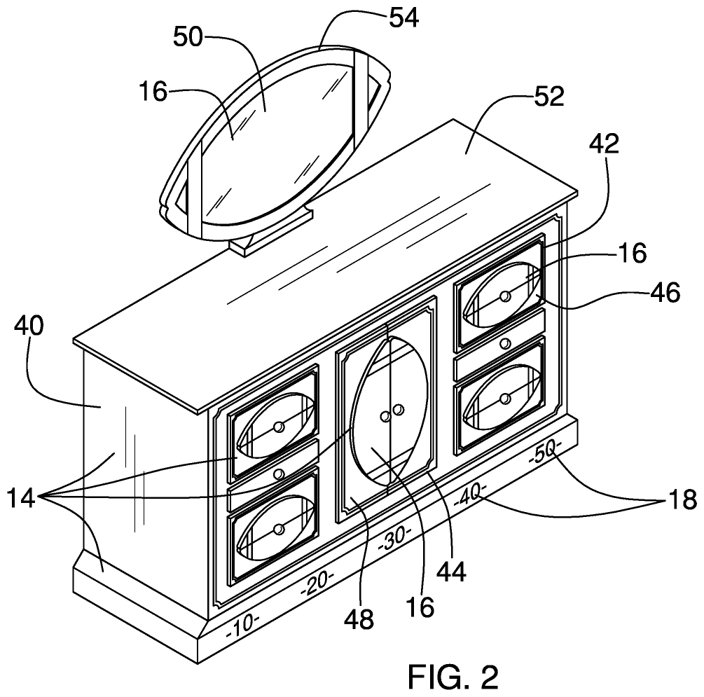

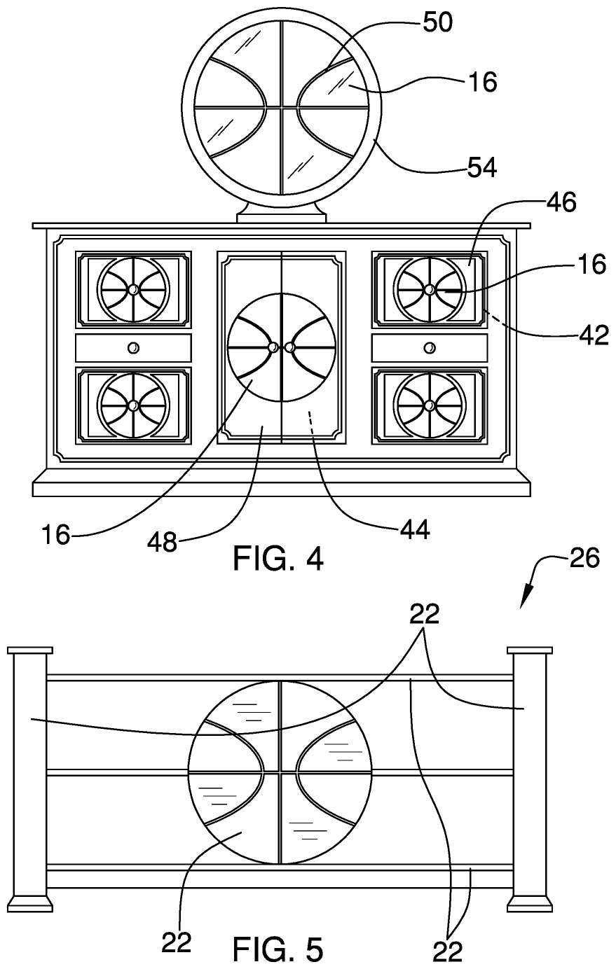

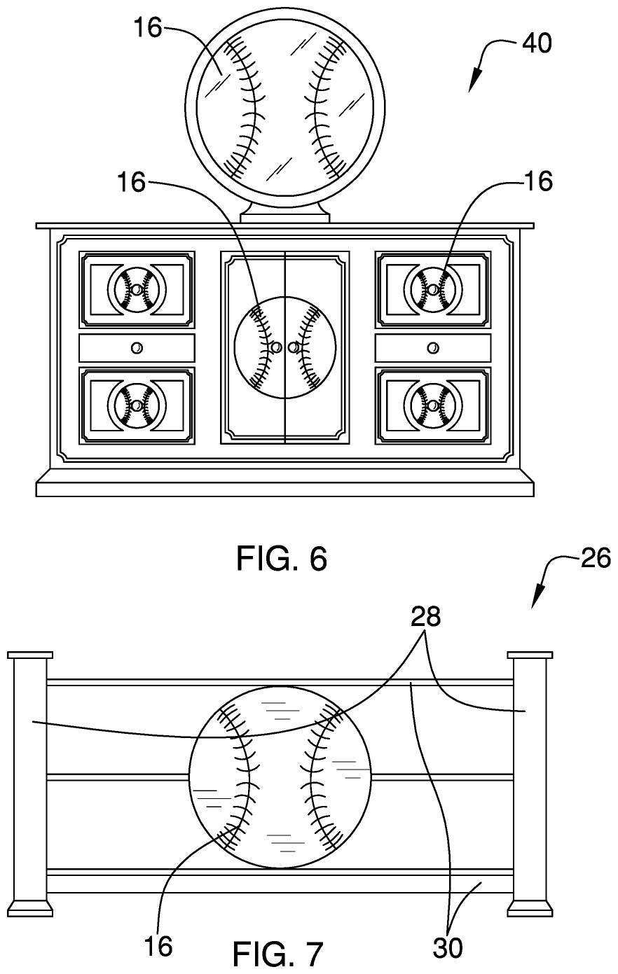

For example, the sport module 16 may be football shaped, as shown in FIGS. 1 and 2, basketball shaped, as shown in FIGS. 4 and 5, and baseball shaped, as shown in FIGS. 6 and 7.

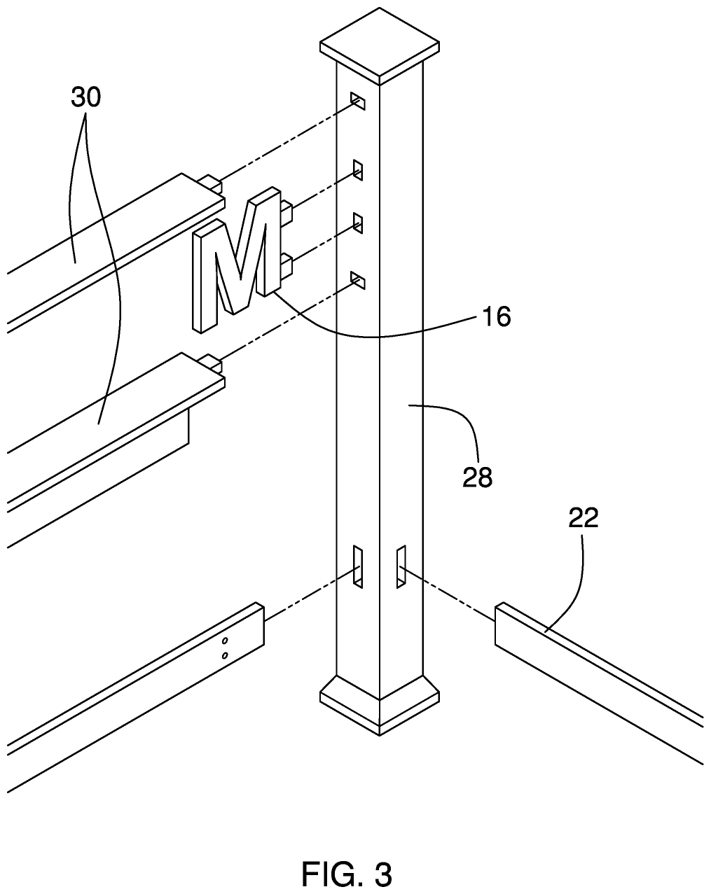

The sport module 16 may be three-dimensional, as shown in FIG. 3, or substantially two-dimensional, as shown with the numbers 18 engaged to the article of furniture 12 in FIG. 2. The sport module 16 may be fabricated by three-dimensional printing, or other manufacturing technique, such as, but not limited to, carving, routing, molding, turning, and the like.

The article of furniture 12 is one of a plurality of articles of furniture 12. The plurality of articles of furniture 12 is configured to at least partially furnish a sports themed room.

The plurality of articles of furniture 12 may comprise a bedframe 20, as shown in FIG. 1. At least one of a siderail 22, a headboard 24, and a footboard 26 of the bedframe 20 comprises a sport module 16. Each of the headboard 24 and the footboard 26 may comprise a pair of corner posts 28. At least one of the pairs of corner posts 28 has a sport module 16 engaged thereto and extending therebetween, as shown with the headboard 24 depicted in FIG. 1. Each of the headboard 24 and the footboard 26 may comprise a pair of rails 30. At least one of the pair of rails 30 has a sport module 16 engaged thereto and extending therebetween, as shown with the footboard 26 depicted in FIG. 5.

The plurality of articles of furniture 12 also may comprise a nightstand 32, as shown in FIG. 1. The nightstand 32 comprises a base 34 and a top 36, which have a support 38 engaged thereto and extending therebetween. At least one of the base 34, the top 36, and the support 38 comprises a sport module 16. As shown in FIG. 1, the nightstand 32 may comprise a sport module 16 that is engaged to and extends between the top 36 and the base 34.

The plurality of articles of furniture 12 also may comprise a dresser 40. The dresser 40 comprises at least one of a drawer 42 and a cabinet 44. At least one of a faceplate 46 of the drawer 42 and a door 48 of the cabinet 44 comprises a sport module 16. For example, the doors 48 of the cabinets 44 depicted in FIGS. 2, 4, and 6 comprise sport modules 16 depicting a football, a basketball, and a baseball, respectively. The faceplates 46 of the drawers 42 depicted in FIGS. 2, 4, and 6 comprise sport modules 16 depicting a football, a basketball, and a baseball, respectively.

A mirror 50 may be engaged to the dresser 40 and extend from an upper end 52 thereof, as shown in FIG. 6. The mirror 50 comprises a sport module 16. The sport module 16 may comprise a frame 54 of the mirror 50.

In use, the articles of furniture 12 are positioned in a bedroom to create a sports themed bedroom.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

1. A sports themed furniture assembly comprising:
an article of furniture comprising a plurality of elements, the elements being interconnected, at least one of the elements comprising a sport module, wherein the sport module is configured for depicting at least one of a team name, a team logo, a team name initial, a sport name, a sporting league name, a sporting league acronym, and a piece of equipment utilized in a sport;
the article of furniture being one of a plurality of articles of furniture, wherein the plurality of articles of furniture is configured for at least partially furnishing a sports themed room, wherein the plurality of articles of furniture comprises bedroom furniture, wherein the plurality of articles of furniture comprises a bedframe, at least one of a siderail, a headboard, and a footboard of the bedframe comprising a sport module, wherein each of the headboard and the footboard comprises a pair of corner posts; and
at least one of the pairs of corner posts having a pair of spaced wells and the sport module having a pair of spaced protrusions complementary to the wells wherein the sports module is engaged to the corner post by insertion of the protrusions into the wells.

2. The sports themed furniture assembly of claim 1, wherein the sport module is three-dimensional.

3. (canceled)

4. (canceled)

5. (canceled)

6. (canceled)

7. The sports themed furniture assembly of claim 1, wherein each of the headboard and the footboard comprises a pair of rails, at least one of the pair of rails having a sport module engaged thereto and extending therebetween.

8. The sports themed furniture assembly of claim 1, wherein the plurality of articles of furniture comprises a nightstand, the nightstand comprising a base and a top having a support engaged thereto and extending therebetween, at least one of the base, the top, and the support comprising a sport module.

9. The sports themed furniture assembly of claim 8, wherein the nightstand comprises a sport module engaged to and extending between the top and the base.

10. The sports themed furniture assembly of claim 1, wherein the plurality of articles of furniture comprises a dresser, the dresser comprising at least one of a drawer and a cabinet, at least one of a faceplate of the drawer and a door of the cabinet comprising a sport module.

11. The sports themed furniture assembly of claim 10, further including a mirror engaged to the dresser and extending from an upper end thereof, the mirror comprising a sport module.

12. The sports themed furniture assembly of claim 11, wherein the sport module comprises a frame of the mirror.

13. A sports themed furniture assembly comprising:
an article of furniture comprising a plurality of elements, the elements being interconnected, at least one of the elements comprising a sport module, wherein the sport module is configured for depicting at least one of a team name, a team logo, a team name initial, a sport name, a sporting league name, a sporting league acronym, and a piece of equipment utilized in a sport, the sport module being three-dimensional;
the article of furniture being one of a plurality of articles of furniture, wherein the plurality of articles of furniture is configured for at least partially furnishing a sports themed room, the plurality of articles of furniture comprising bedroom furniture;
the plurality of articles of furniture comprising a bedframe, at least one of a siderail, a headboard, and a footboard of the bedframe comprising a sport module, each of the headboard and the footboard comprising a pair of corner posts, at least one of the pairs of corner posts having a pair of spaced wells and the sport module having a pair of spaced protrusions complementary to the wells wherein the sports module is engaged to the corner post by insertion of the protrusions into the wells, each of the headboard and the footboard comprising a pair of rails, at least one of the pair of rails having a sport module engaged thereto and extending therebetween;
the plurality of articles of furniture comprising a nightstand, the nightstand comprising a base and a top having a support engaged thereto and extending therebetween, at least one of the base, the top, and the support comprising a sport module, the nightstand comprising a sport module engaged to and extending between the top and the base;
the plurality of articles of furniture comprising a dresser, the dresser comprising at least one of a drawer and a cabinet, at least one of a faceplate of the drawer and a door of the cabinet comprising a sport module; and
a mirror engaged to the dresser and extending from an upper end thereof, the mirror comprising a sport module, the sport module comprising a frame of the mirror.

14. (canceled)
